(19) United States
(12) Patent Application Publication
(10) Pub. No.: US 2005/0251687 A1
(43) Pub. Date: Nov. 10, 2005

(54) File cabinet with secure access

(76) Inventors: Thomas J. Bachinski, Lakeville, MN (US); David J. Oja, Burnsville, MN (US)

Correspondence Address: JONES DAY, 77 WEST WACKER, CHICAGO, IL, 60601-1692, US

(21) Appl. No.: 10/635,732

(22) Filed: Aug. 6, 2003

(51) Int. Cl. H04K 1/00; H04L 9/00

(52) U.S. Cl. 713/186

(57) ABSTRACT

A secured file cabinet having a mechanical locking mechanism movable between locked and unlocked positions and a biometric data scanner for activating the locking mechanism. The biometric data scanner is based on fingerprints, iris recognition, retina recognition, voice recognition or any other biometric data. The scanner initiates a signal, if a match is found with stored data, to a solenoid in one embodiment, or a motor in another embodiment, to move a tab or a bar from a locking position relative to a file cabinet drawer. A light system may be used to indicate whether the cabinet is locked or unlocked.

### BACKGROUND OF THE INVENTION

File cabinets having one or more file drawers are well known in the office furniture trade. Such file cabinets typically include a housing closed on the top, bottom, back, and both sides, and open on the front side. One or more file drawers are supported by rails on the inside of the housing, and can be extended outwardly in an open position through the open front side of the housing. It is often desirable to store valuable articles or documents embodying confidential information in such file drawers. Thus, a number of different lock mechanisms have been used to secure file drawers from unauthorized access. Such lock mechanisms usually include a standard lock and key arrangement. With a standard lock and key, the file cabinet can be opened only by a person having physical possession of the key. This can result in several difficulties. First, keys must be provided to each individual who is authorized to have access to the file cabinet. If such an authorized individual loses or misplaces the key, or simply does not have the key with them at the time they need to open the file cabinet, they will not be able to do so. Conversely, the more keys that are made, the greater the likelihood will be that an unauthorized individual will acquire a key and thereby have unauthorized access to the file cabinet. Further, mechanical locks can be broken into by certain individuals even if they do not have the key.

Because of these difficulties, security systems have been developed in which secured access is provided by means other than a conventional mechanical lock and key. In such systems, access to confidential information is generally controlled by one or more of three different factors: what an individual has, such as a card or token with a magnetic stripe that allows access; what an individual knows, such as a password or entry code; and who an individual is, such as by iris, fingerprint, or voice patterns. The first two factors are commonly used together such as in banking cash card systems. Fingerprint scanners have become available for use in providing controlled access to personal and laptop computers, for use in verifying employee time clock information, and for allowing entry through doorways.

U.S. Pat. No. 6,130,621 discusses these three factors of personal identification, and discloses a lockable container such as a file cabinet using the first two factors, namely, a token that generates a non-predictable code, coupled with a personal code known to an authorized user. The system can include a processor that that allows access and that maintain an audit trail of access to the system, including the time and date of access and the identity of the individual s who gained access to the system.

U.S. Pat. No. 5,245,329 discloses an access control system in which a mechanical key is coded with data that is a biometric feature of the user, such as a fingerprint. The system further may include a fingerprint scanner, and a processor that compares the scanned fingerprint with the fingerprint data encoded on the mechanical key. Access is then granted to the user by an electrical strike or an electrical release. The system can include means for reporting the time of day and control point of the access.

U.S. Patent Application Publication No. U.S. 2002/0147525 A1 discloses a locking system for a series of commercial storage lockers, wherein access is provided by fingerprint identification.

Other patents disclosing fingerprint recognition access systems include U.S. Pat. No. 4,768,021, U.S. Pat. No. 5,701,770, U.S. Pat. No. 6,260,300, and U.S. Pat. No. 6,374,652.

It is thus one object of the invention to provide a file cabinet that provides keyless access to authorized individuals only, yet securely denies access to unauthorized individuals.

It is another object of the invention to provide a file cabinet having a controlled access means that distinguishes between persons authorized to have access and persons not authorized to have access based on fingerprint identification.

### SUMMARY OF THE INVENTION

In accordance with the invention, a file cabinet having a housing and at least one drawer comprises a lock mechanism for providing secured access to the drawer or drawers. The lock mechanism is movable between unlocked and locked positions. The operation of the lock mechanism is controlled by an actuator that is coupled via a computer processor to a biometric data scanner such as a fingerprint scanner. The processor has stored therein sets of biometric data, such as fingerprint scans, of persons authorized to have access to the contents of the file cabinet. A person desiring to open a drawer of the file cabinet places their finger on the fingerprint scanner. If the person's fingerprint matches a data set of one of the fingerprints stored in the processor, the processor will activate the actuator to unlock the lock mechanism and allow the drawers to be opened. If the person's fingerprint does not match any of the fingerprint data stored in the processor, the processor will not signal the actuator to unlock the lock mechanism, the lock mechanism will remain locked, and access will be denied to the unauthorized user. The file cabinet can also include one or more additional security factors, such as the requirement of a personal code, a card with a magnetic stripe, or the like, to further enhance the security of the contents of the file cabinet.

More particularly, the instant invention encompasses not only the file cabinet with biometric data actuated locking means as described above, but also various processes for maintaining the file cabinet in a locked or unlocked condition. For some lock configurations, the actuator operates by holding a part of the lock mechanism in a raised configuration such as by electromagnetic energy. In such cases, the cabinet will remain in its unlocked condition for a relatively short duration, such as ten seconds or less. This allows sufficient time for a user to pull open a file drawer while the cabinet is in the unlocked condition, but immediately returns the cabinet to the locked condition so that the other drawers cannot be opened until the mechanism is reactivated by the actuator. Further, when the drawer that had been opened is closed, the entire cabinet reverts to the locked condition. This helps to prevent unauthorized access because authorized users cannot inadvertently leave the cabinet unlocked. In other instances, it might be desirable to leave the file cabinet in an unlocked condition for an extended period of time. In that case, an actuator that maintains a locking mechanism in a raised condition by electromagnetic energy would use excessive electricity and could be difficult to maintain. An alternative is for the actuator to be coupled to a rotating cam, such that when the cam is rotated through a predetermined arc of rotation it holds the locking mechanism in a raised position for an indefinite period. When the actuator is activated again, it causes the cam to rotate through another predetermined arc of rotation and lowers the locking mechanism into the locked condition.

In either embodiment, the processor can be programmed to provide means for keeping track of those persons who have accessed the file cabinet, including the identity of the person who unlocked the cabinet, date of access, the time of access, and time the cabinet was locked. For the second embodiment described above in which it is necessary to activate the mechanism to lock the cabinet, the processor can also identify the individual who locked the cabinet.

The foregoing and other objects, features, and advantages of the invention will be apparent form the following detailed description read in light of the accompanying figures.

### DESCRIPTION OF THE FIGURES

FIG. 1 is a perspective view of a vertical file cabinet having a controlled access system of the instant invention.

FIG. 2 is a front elevation view of a lock bar with locking tabs and an associated file drawer of a filing cabinet.

FIG. 3 is a side elevation view of the lock bar and cabinet drawer of FIG. 2.

FIG. 4 is an enlarged view of the connection between the locking tab of the lock bar with the drawer of the file cabinet taken within circle 4-4 of FIG. 3.

FIG. 5 is an enlarged view of the top of the lock bar and the inner surface of the top wall of the file cabinet housing taken within circle 5-5 of FIG. 3.

FIG. 6 is an enlarged view of the side of the file drawer of FIG. 3.

FIG. 7 is a perspective view of a lateral file cabinet having a secured access system of the instant invention

FIG. 8 is a front elevation view of a lock bar for use with the file cabinet of FIG. 7, shown in the locked position.

FIG. 9 is an enlarged side elevation view of the lock mechanism of the lock bar of FIG. 8.

FIG. 10 is a top plan view of the lock mechanism of FIG. 9.

FIG. 11 is a front elevation view of a lock bar for use with the file cabinet of FIG. 7, shown in the unlocked position.

FIG. 12 is an enlarged side elevation view of the lock mechanism of the lock bar of FIG. 11.

FIG. 13 is a front elevation view as shown in FIG. 11 showing the lock bar connected to a drawer stop mechanism.

FIG. 14 is a front elevation view of a lock bar for use with the file cabinet of FIG. 7, shown between the locked and the unlocked position.

FIG. 15 is an enlarged front elevation view of the motor driven actuator of FIG. 14

### DETAILED DESCRIPTION OF A PREFERRED EMBODIMENT

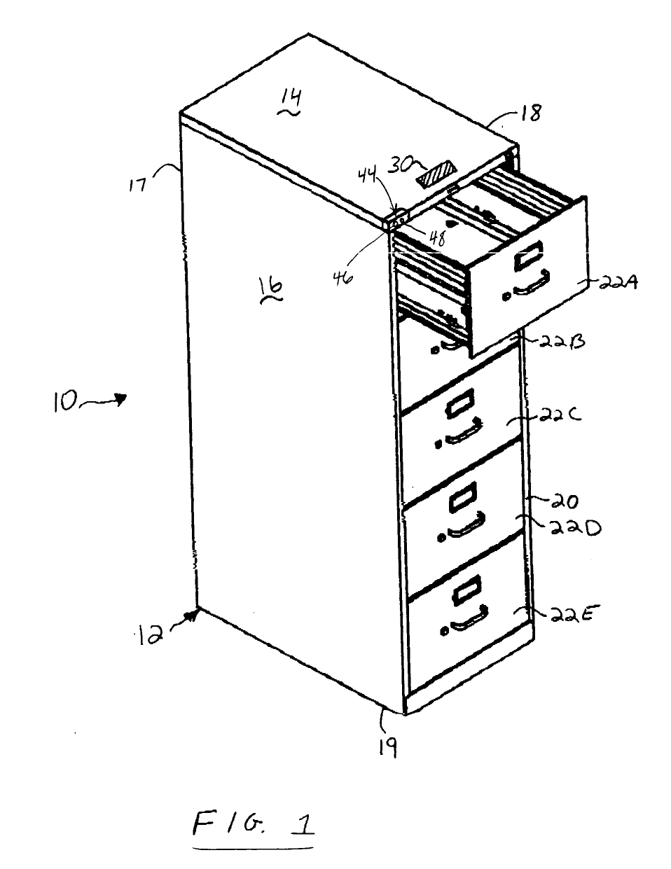

As illustrated in FIG. 1, a file cabinet 10 of standard construction comprises a housing 12, the housing comprising a top wall 14, side walls 16 and 18, a bottom wall 19, a back wall 17, and a front panel 20. In the illustrated embodiment, the front panel 20 includes five openings through which can extend each of five file drawers, 22A, 22B, 22C, 22D, and 22E, respectively. The number of file drawers in the cabinet is not critical, and can be greater or less than five.

Associated with the file cabinet 10 is a fingerprint scanner 30. In the illustrated embodiment, the fingerprint scanner 30 is shown mounted in the top wall 14 of the housing 12, although it can be mounted on any portion of the housing 12, or even on a wall or table adjacent to the housing 12, as long as it is easily reached by the hand of a user of the file cabinet. Fingerprint scanner 30 can be of the optical type or the capacitance type, both of which are known in the fingerprint scanning art, in accordance with the requirements of a particular installation.

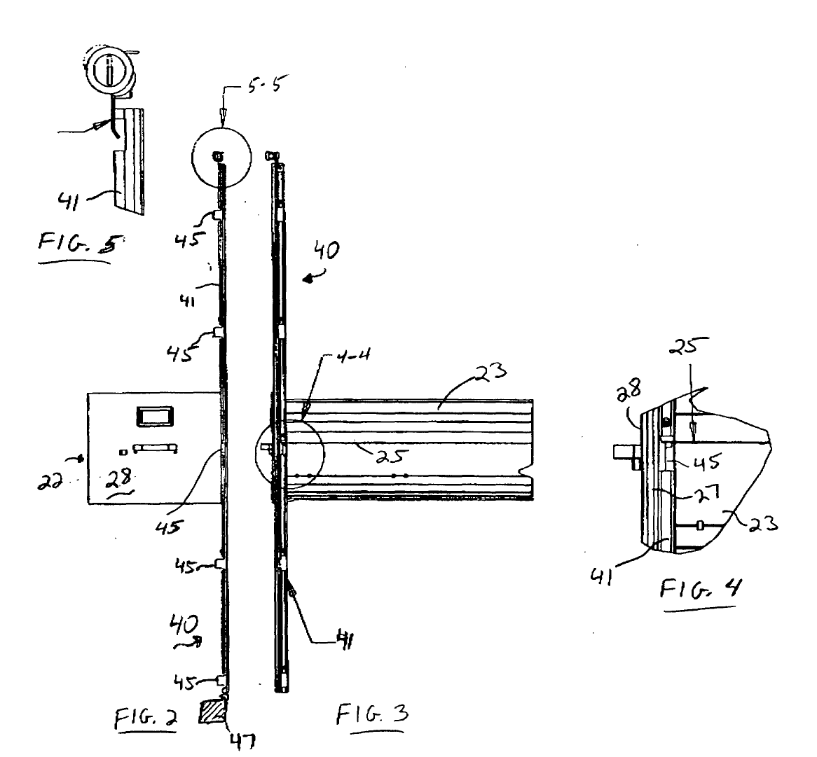

As shown in FIGS. 2, 3, the lock mechanism of the file cabinet includes a lock bar 40 mounted on the inside of one of the side walls 16, 18. In the illustrated embodiment, the lock bar 40 is mounted on the inner surface of side wall 18. The lock bar 40 comprises a vertical bar 41 that spans the vertical length of the interior of the cabinet housing 12 from about the center of the lowermost drawer 22E to near the underside of the top housing wall 14. A plurality of locking tabs 45 are disposed along the length thereof, there being one locking tab 45 for each drawer 22A-E.

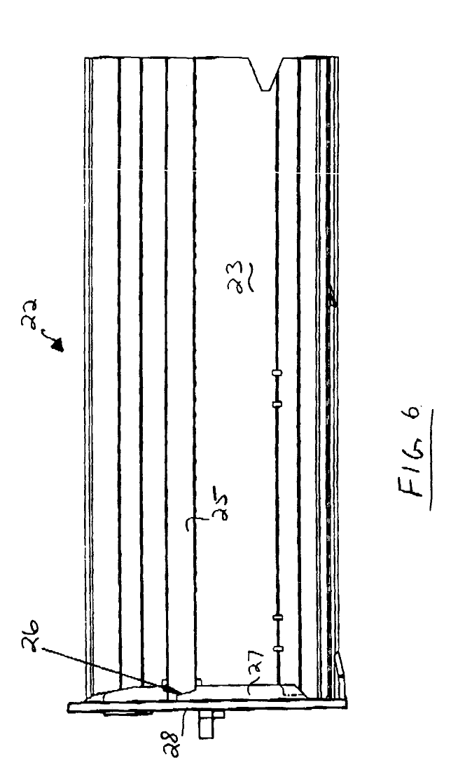

As shown in FIGS. 3, 4, and 6, each of the drawers 22 has a side wall 23 with a channel 25 formed therein, and each channel 25 has a groove 26 formed therein immediately adjacent the rearward facing surface 27 a front wall 28 of the drawer 22. The locking tabs 45 are spaced such that one locking tab 45 is positioned to engage each of the grooves 26 when the locking bar 45 is in its locked condition. The bar 40 is vertically slidable between an upper lock position, in which the locking tabs 45 engage the drawer side wall grooves 26, and a lower unlocked position in which the locking tabs 45 are disengaged from the grooves 26, thereby allowing the drawer 22 to be pulled forwardly from file cabinet housing 12. The vertical displacement between the locked and unlocked positions of the lock bar 40 can be quite small, on the order of about ½ inch. In the illustrated embodiment, the actuator for moving the vertical lock bar 40 between its upper locked position and its lower unlocked position is in the form of a solenoid 47 operatively coupled to the lock bar 40.

In operation, the fingerprint scanner 30 has associated therewith a computer processing unit such as a conventional microprocessor, not shown. The microprocessor has stored therein a set of biometric data for each user authorized to have access to the file cabinet. These sets of biometric data most commonly will be fingerprint data, either optical or capacitance, but alternatively can be iris data, retina data, voice recognition data, or other biometric data suitable for identifying an individual. When a user approaches the locked file cabinet, the user places his or her finger on the scanner 30. The scanner reads the fingerprint and sends a signal to the microprocessor. If data corresponding to the scanned fingerprint corresponds to a set of data of authorized users already stored in the microprocessor, the microprocessor will send a signal to activate a solenoid 47 for a predetermined period of relatively short duration, generally about ten seconds or less, and preferably about five seconds.

When the solenoid 47 is activated, the bar 40 is moved slidably downward from its upper locked position to its lower unlocked position. When it is lowered, locking tabs 45 disengage from the grooves 26, and a drawer 22 can be pulled to the open position. After the predetermined period of solenoid activation, the solenoid is no longer powered, and the lock bar 40 pulled back up by springs into the locking position. Then no other drawers can be opened until a user again places a fingerprint on the fingerprint scanner that corresponds to a fingerprint data set stored in the microprocessor, and activates the solenoid to lower the lock bar. When the user is ready to close the open drawer, the user can push the drawer into the closed position back in the file cabinet housing, and locking tab 45 will once again engage groove 26 in the side of the drawer, so that the drawer will once again be secure from unauthorized access.

A light system 44, FIG. 1, may also be used on the cabinet to indicate whether the cabinet is locked or unlocked. For example, the light system may include a red light 46 to visually show that the cabinet is locked; a green light 48 may be used to show that the cabinet is unlocked. Any other light color arrangement may be used and any convenient location may be chosen for the light system to be incorporated with the cabinet. If multiple cabinets are ganged together one or more light systems may be used.

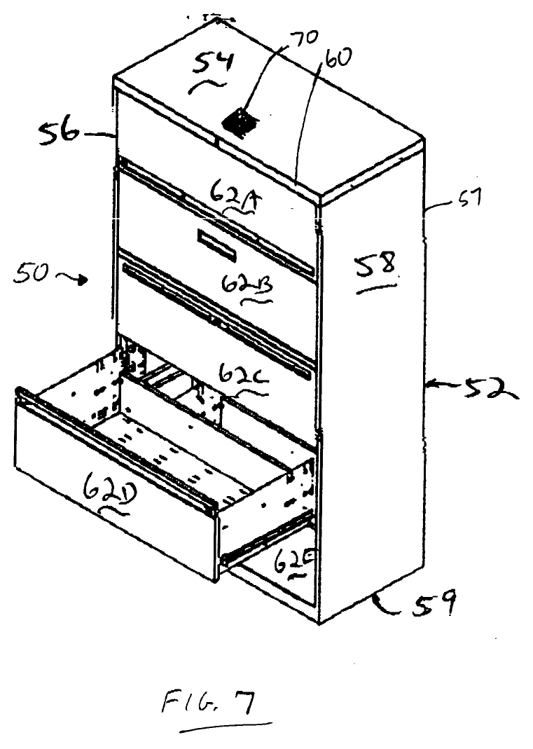

FIG. 7 illustrates another embodiment of the instant invention, adapted for use with lateral file cabinets. A lateral file cabinet 50 of standard construction comprises a housing 52, the housing including a top wall 54, two side walls 56 and 58, a bottom wall 59, a back wall 57, and a front panel 60. In the illustrated embodiment, the front panel 60 includes five openings through which can extend each of five file drawers, 62A, 62B, 62C, 62D, and 62E, respectively. The number of file drawers in the cabinet is not critical, and can be greater or less than five.

Associated with the file cabinet 50 is a fingerprint scanner 70. In the illustrated embodiment, the fingerprint scanner 70 is shown mounted in the top wall 54 of the housing 52, although it can be mounted on any portion of the housing 52, or even on a wall or table adjacent to the cabinet 50, as long as it is easily reached by the hand of a user of the file cabinet. The fingerprint scanner 70 can be of the optical type or the capacitance type, both of which are known in the fingerprint scanning art, in accordance with the requirements of a particular installation.

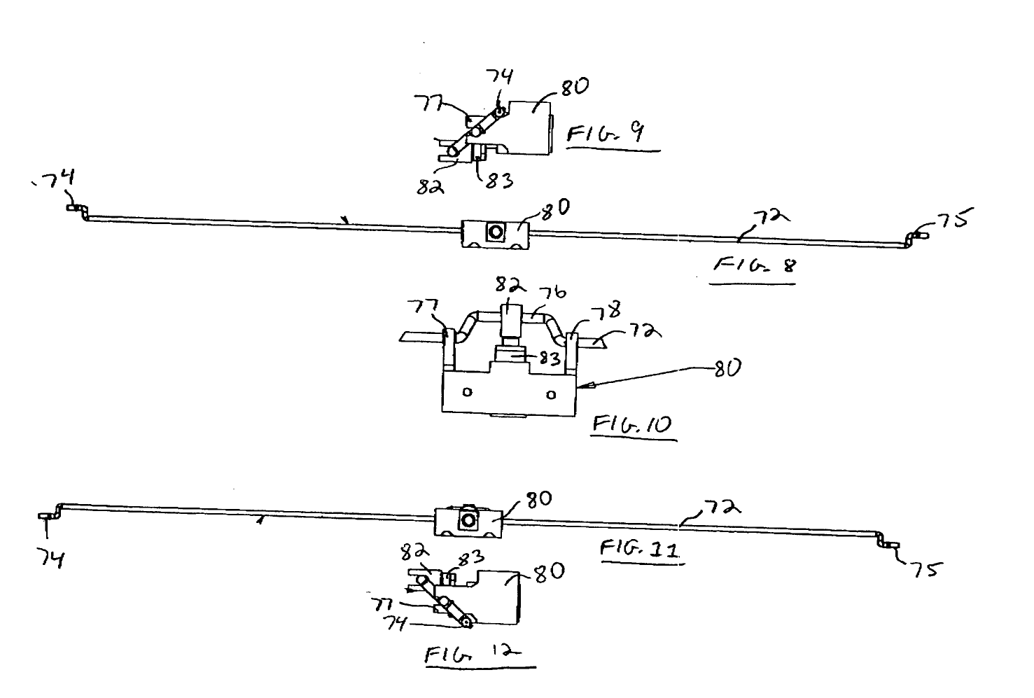

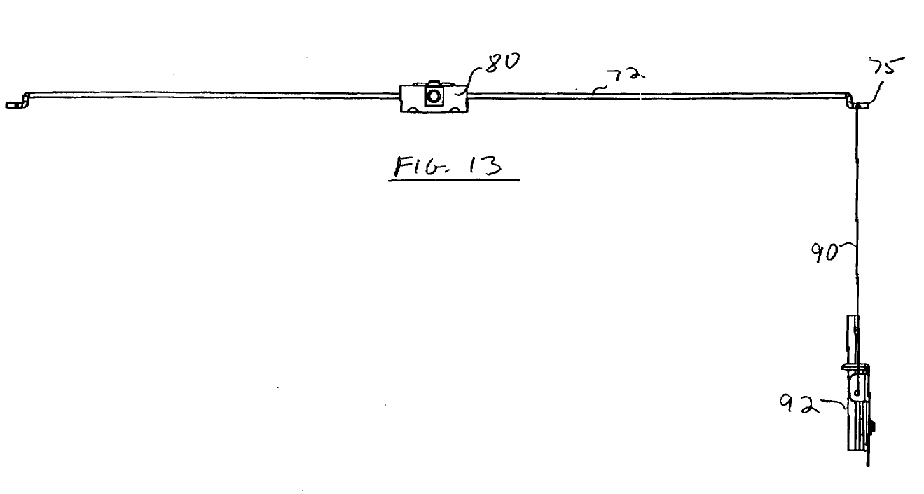

As shown in FIG. 8, a horizontally disposed lock bar 72 having forked ends 74, 75, is mounted to motor driven actuator 80. The lock bar 72 and the motor driven actuator 80 are adapted to be mounted in the interior of the housing 52 near the underside of the top wall 54. The lock bar 72 is mounted to the actuator 80 by two mounting member 77, 78 that extend rearwardly from the actuator 80, the mounting members 77, 78 each having an orifice aligned with one another for receiving the lock bar 72 therethrough. The lock bar 72 includes a bight 76 disposed between the mounting members 77,78, which bight 76 is held by a movable clamp 82 of the actuator 80. When the movable clamp 82 is in a lower position, as shown in FIGS. 8, 9, the lock bar 72 is rotated such that the forked ends 74, 75 are oriented upwardly. When the movable clamp 82 is in a raised position as shown in FIGS. 11, 12, the lock bar is rotated such that the forked ends 74, 75 are positioned upwardly.

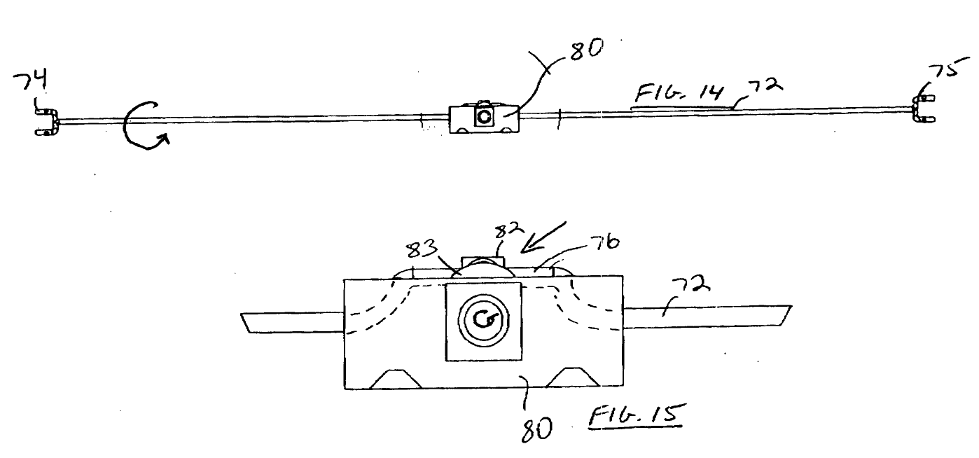

The clamp 82 is movable between its raised and lowered positions by means of a cam 83. When the motor 80 rotates the cam 83 by 180°, the cam 83 raises the clamp 82 which raises the bight 76, causing the lock bar 72 to rotate within the mounting members 77, 78 to an unlocked position. When the motor 80 rotates the cam 82 another 180°, the cam 83 lowers the clamp 82 which lowers the bight 76, causing the lock bar 72 to rotate within the mounting members 77, 78 to a locked position. As shown in FIG. 13, the forked end 75 of the lock bar 72 is operatively connected to a wire or cable 90 that connects the lock bar 72 to a locking mechanism 92 that interfaces with the drawers 62A-E. When the lock bar 72 is in the unlocked configuration of FIGS. 8, 9, the lock bar 72 lowers the wire 90 such that the locking mechanism 92 unlocks the drawers 62A-E, and when the lock bar 72 is in the locked configuration of FIGS. 11, 12, the lock bar 72 raises the wire 90 such that the locking mechanism 92 locks the drawers 62 A-E. It will be appreciated that once the motor 80 is no longer energized, the cam 83 will remain in whatever position it was last rotated, so that the file cabinet will remain in either a locked condition or an unlocked condition until the motor 80 is activated again.

In operation, the fingerprint scanner 70 has associated therewith a computer processing unit such as a conventional microprocessor, not shown. The microprocessor has stored therein a set of biometric data for each user authorized to have access to the file cabinet. These sets of biometric data most commonly will be fingerprint data, either optical or capacitance, but alternatively can be iris data, retina data, voice recognition data, or other biometric data suitable for identifying an individual. When a user approaches the locked file cabinet, the user places his or her finger on the scanner 70. The scanner reads the fingerprint and sends a signal to the microprocessor. If data corresponding to the scanned fingerprint corresponds to a set of data of authorized users already stored in the microprocessor, the microprocessor will send a signal to circuitry to activate motor 80 for a period of time sufficient to cause cam 83 to rotate 180°. If the cabinet was previously locked, the rotation of the cam 83 will raise the clamp 82, causing the lock bar 72 to rotate to the unlocked configuration of FIGS. 11, 12, thereby operating on the wire 90 and the locking mechanism 92 to unlock the file cabinet. The cabinet will remain in the unlocked configuration until another authorized user places their finger on the fingerprint scanner 70. This will cause the microprocessor to send a signal to circuitry to activate the motor 80 for a period of time sufficient to cause the cam 83 to rotate another 180°. This rotation of the cam 83 will lower the clamp 82, causing the lock bar 72 to rotate to the locked configuration of FIGS. 8, 9, thereby operating on the wire 90 and the locking mechanism 92 to lock the file cabinet. The cabinet will remain in this position until approached by another authorized user.

In either configuration, the microprocessor can be programmed to keep track of the identity of those who attempt to gain access to the file cabinet, whether authorize or unauthorized. The microprocessor can keep track of the times and dates of any attempt to gain access, thereby providing security personnel with an audit of users.

It will be appreciated that while the locking mechanism has been illustrated in each embodiment for use with only one file cabinet, in fact several file cabinets can be wired together in series so that an authorized user can gain access to several cabinets at once. Alternatively, the microprocessor can be programmed so that certain users are allowed access to only certain file cabinets.

The foregoing descriptions of preferred embodiments are for purposes of illustration only, and are not intended to limit the scope of the instant invention, which is intended to cover all such embodiments and their equivalents, as set forth in the following claims.

1. A file cabinet having a housing and one or more file drawers and a means for mechanically locking said one or more file drawers, said means for mechanical locking being movable between an unlocked position and a locked position, the file cabinet comprising a biometric data scanner, a computer processor capable of storing sets of biometric data, and operatively coupled to said biometric scanner to enable comparisons to be made between scanned sets of biometric data and stored sets of biometric data, an actuator operatively coupled to said processor and to said mechanical locking means, whereby when said biometric data scanner scans a set of biometric data that corresponds to a previously stored set of biometric data, the computer processor causes the actuator to move the locking mechanism from a locked position to an unlocked position for period of time of predetermine duration, to allow access to the file cabinet.

2. The file cabinet of claim 1 wherein said lock mechanism further comprises a substantially vertically disposed lock bar movable between a lower locking position and a raised unlocking position when the fingerprint scanner reads the fingerprint of an authorized user.

3. The file cabinet of claims 2 wherein said actuator comprises a solenoid operatively coupled to said lock bar.

4. The file cabinet of claim 3 wherein said period of time wherein said lock bar is in the unlocked position is on the order of about 10 seconds or less.

5. The file cabinet of claim 1 wherein said lock mechanism further comprises a substantially horizontally disposed lock bar movable between a lower locking position and a raised unlocking position when the fingerprint scanner reads the fingerprint of an authorized user.

6. The file cabinet of claims 5 wherein said actuator comprises a motor-driven cam operatively coupled to said lock bar to raise said bar to the unlocked position.
